(19) United States
(12) Patent Application Publication
(10) Pub. No.: US 2006/0274037 A1
(43) Pub. Date: Dec. 7, 2006

(54) Onboard pointer system

(76) Inventor: Sheila Kay Stewart, Cedar Park, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/146,773

(22) Filed: Jun. 6, 2005

(51) Int. Cl. G09G 5/08

(52) U.S. Cl. 345/157

(57) ABSTRACT

A laptop computer includes a wireless pointer device which is located within the base of the laptop. In an exemplary embodiment, the pointer device is an infrared mouse designed to fit within a cradle mechanism. In one example, the cradle mechanism is located centered and below the keyboard and may be inserted in, and replace, the space generally used for the touch-pad surface of a touchpad pointer system. The mouse is recharged when engaged with the cradle mechanism. The cradle mechanism may be selectively opened to release the wireless mouse or pointer device for use in interacting with the laptop computer.

### FIELD OF THE INVENTION

The present invention relates generally to information processing systems and more particularly to a methodology and implementation for a laptop computer which includes a pointer device housed in a pointer compartment within the laptop computer.

### BACKGROUND OF THE INVENTION

Current onboard pointing systems for laptop computers are not comfortable for all laptop computer users. Current pointers include, inter alia, the use of a mini-joystick in the middle of the keyboard and the use of a touch-pad and switching buttons below the keyboard. Many users prefer the use of a standard external mouse device. However, the use of an external mouse requires a port connection, even for wireless models. Further, mouse units require storage separate from the laptop and are cumbersome to bring along when a user is carrying the laptop from one location to another.

Thus, there is a need for an improved methodology and system in which a mouse or other pointer device can be carried integrally with the laptop computer and easily removed to enable user interaction with the laptop.

### SUMMARY OF THE INVENTION

A laptop computer includes a wireless pointer device or unit which is located within the base of the laptop. In an exemplary embodiment, the pointer device is an infrared and/or radio frequency mouse designed to fit within a cradle mechanism within a laptop computer. In one example, the cradle mechanism is located centered and below the keyboard and may be inserted into, and replace, the space generally used for a touch-pad surface of a touch-pad pointer system. The mouse is automatically recharged when it is housed within the cradle mechanism. The cradle mechanism, in addition to the charging feature, is designed to snuggly hold the mouse unit to prevent movement of the mouse unit while the laptop is being carried. The cradle mechanism may be selectively opened to release the wireless mouse or pointer device for use in interacting with the laptop computer.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of computer system in which the present invention may be implemented;

FIG. 2 is an illustration showing an exemplary embodiment of a wireless pointer device which may be used in accordance with the present invention;

FIG. 3 is an illustration of a laptop computer keyboard area and a front panel showing an exemplary mouse cradle mechanism, a cradle release button and an Infrared (IR) communication system for use with the wireless mouse unit;

FIG. 4 is a top view of the front panel area of the keyboard area showing the cradle mechanism extended away from the laptop and the mouse device and recharging system within the cradle mechanism; and

FIG. 5 is a view of the front panel of the laptop computer and the wireless mouse removed from the cradle mechanism and in position to interface with the IR communication port of the laptop computer.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

As used herein, the terms “mouse”, “mouse-type device”, “mouse unit”, “pointer” and/or “pointer device” are all used interchangeably in a generic sense and include any input device which may be coupled (either by wire or wirelessly) to a computer system to enable input to, and output from, the coupled computer system.

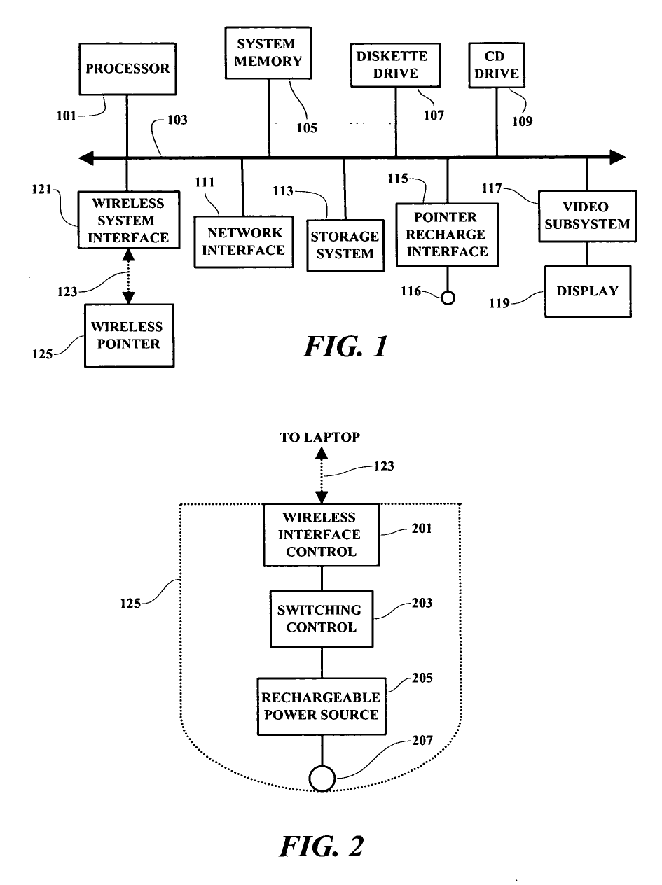

In FIG. 1, a laptop system processor 101 is connected to a system bus 103. A system memory 105, a diskette drive 107, a CD drive 109, a network interface 111, a storage system 113, and a video subsystem 117 including a display device 119 are also coupled to the system bus 103 in the illustrated example. As shown, a wireless system interface 121 is arranged to be coupled 123 to a wireless pointer device 125.

In an exemplary embodiment, an infrared (IR) technology is implemented to couple 123 the wireless pointer device 125 to the system interface 121. Radio frequency systems may also be used to implement the wireless coupling 123 between the wireless pointer or mouse 125 and the system interface 121. Other components may also be coupled to the system bus 103 but are not specifically shown in FIG. 1 for the sake of clarity. For example, a battery or other power source supply means is also connected to the system bus 103 in order to enable a charging of a connected wireless pointer device as is hereinafter discussed in greater detail.

An exemplary embodiment of the pointer or mouse 125 is illustrated in FIG. 2. As shown, the mouse 125 includes a wireless interface control 201 for enabling the coupling 123 the mouse to the laptop system interface 121. The mouse 125 also includes and a switching control unit 203. The switching control unit 203 is designed to detect and transmit mouse “clicks” or user actuations of the push-button switches on the mouse device 125 to the wireless system interface 121. Also included within the mouse unit 125 is a battery or rechargeable power source 205 and a recharge terminal 207. In the illustrated example, the pointer recharge terminal 207 of the mouse unit 125 is designed to engage with a system recharge terminal 116 from the power recharge interface 115 of the laptop computer to recharge the wireless mouse unit 125.

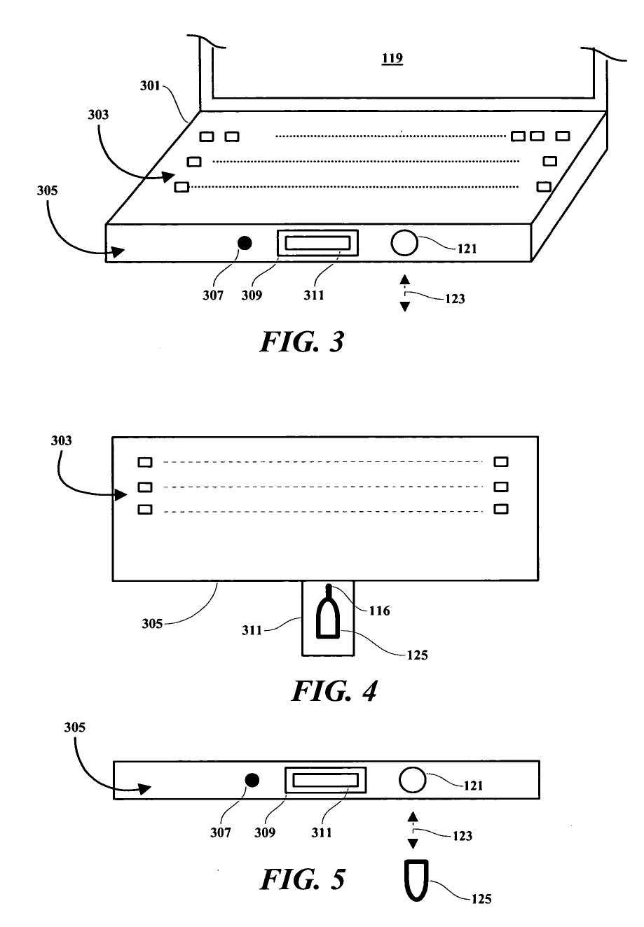

As shown in FIG. 3, a laptop computer 301 includes a display 119, and a base unit including a keyboard area 303 and a front panel 305. In the present example, a mouse cradle unit or platform 311 is arranged within a housing structure or cradle compartment 309 in the from panel 305 of a laptop computer 301. The cradle may be released from the laptop housing by actuating the release button 307 which is also located in the front panel. The cradle is selectively released and moves to an open position in a manner similar to the releasing of a CD drive platform. The cradle release button 307 is designed to prevent unintentional releasing of the mouse cradle 311. This may be accomplished in many ways including making the release button concave or indented relative to the surface of the front panel 305. An IR port 121 is also shown mounted on the front panel 305 of the laptop computer 301. The IR port 121 is arranged to interface 123 with the wireless pointer 125 when the pointer 125 is removed from the pointer cradle 311 and placed in an appropriate position relative to the IR port 121.

It is noted that, although the preferred embodiment includes a slidable or ejectable cradle platform, the cradle housing structure may also comprise a non-movable cradle compartment within the base unit which has a slide-up hatch or door (not shown) to enable the placement for storage and/or charging of the wireless pointer device within the base unit pointer compartment or housing. The access door to the pointer compartment may also be lockable, in one embodiment, in any of many available locking schemes including thumbwheel combination locks, so that only one or more selected users have access to the wireless pointer device.

In FIG. 4, a top view of the laptop keyboard area 303 of the preferred embodiment illustrates a release of the cradle assembly 311 away from the base unit front panel 305 into an open position. In the open position, the cradle assembly or cradle mechanism 311 is extended away from the base unit to enable the placing of the wireless pointer 125 within the cradle 311. The cradle mechanism is designed to include the system recharge terminal 116 such that when the wireless pointer is placed within the cradle 311, the system recharge terminal 116 is connected to the pointer recharge terminal 207 of the wireless pointer 125 to recharge the pointer unit 125. The cradle assembly or mechanism 311 is also designed, by contouring and shaping the bed of the cradle assembly to firmly hold the pointer unit 125 so as to prevent movement of the pointer unit when the laptop computer is being moved or carried. Other cradle designs may also be implemented to accomplish the function of securing the wireless pointer in place when it is stored in the cradle mechanism. When the cradle release button 307 is depressed and the cradle assembly 311 is released from within the laptop computer base unit, the pointer may be placed within the cradle 311 and connected to the recharge terminal 116, and the cradle assembly may then be closed to a position within the laptop computer base (FIG. 3) when the pointer is not being used. When a user is ready to use the laptop, the cradle release button 307 is actuated, and the cradle assembly opens to a position where the wireless pointer 125 is disengaged from the recharge terminal 116 and removed from the cradle assembly. As shown in FIG. 5, the cradle assembly may then be closed back to its position within the laptop computer after the pointer has been removed. The wireless pointer 125 is then placed in a position where the pointer is able to communicate 123 with the laptop computer through the IR port 121. When a user is finished using the wireless pointer device 125, the pointer device 125 may be replaced within the cradle assembly 311 for recharging and/or “on-board” secure storage while the laptop is moved to a different location.

The method and apparatus of the present invention has been described in connection with a preferred embodiment as disclosed herein. The disclosed methodology may be implemented in a wide range of sequences to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented partially in program code stored on a CD, disk or diskette (portable or fixed), or other memory device, from which it may be loaded into memory and executed to achieve the beneficial results as described herein. Accordingly, the present invention is not intended to be limited to the specific form set forth herein. On the contrary, it is intended to cover such alternatives, modifications, and equivalents, as can be reasonably included within the spirit and scope of the invention.

What is claimed is:

1. A method for integrating a wireless pointer device within a portable computer, said method comprising:
providing a cradle assembly within said portable computer, said cradle assembly being designed to receive said wireless pointer device and carry said wireless pointer device within said portable computer; and
enabling said cradle assembly to be selectively opened to enable removing of said wireless pointer device from said cradle assembly, said cradle assembly including a charge-transfer terminal to enable a charging of said wireless pointer device from said portable computer.

2. The method as set forth in claim 1 wherein said wireless pointer device is a mouse device and said portable computer is a laptop computer.

3. The method as set forth in claim 1 wherein said wireless pointer device communicates with said portable computer through an infrared (IR) coupling.

4. The method as set forth in claim 1 wherein said wireless pointer device communicates with said portable computer through a radio frequency (RF) coupling.

5. The method as set forth in claim 3 wherein said portable computer further includes an IR port for communicating with said wireless pointer device, said IR port being located adjacent to said cradle assembly on a front panel of said portable computer.

6. The method as set forth in claim 1 wherein said wireless pointer device includes means for housing a rechargeable power source, said wireless pointer device further including a charge-receiving terminal for selectively enabling a charging of said rechargeable power source through said charge-receiving terminal.

7. The method as set forth in claim 6 wherein said cradle assembly further includes a charge-transfer terminal, said charge-transfer terminal being arranged to enable a connection to said charge-receiving terminal of said wireless pointer device to selectively charge said wireless pointer device from said portable computer.

8. The method as set forth in claim 7 wherein said charge-transfer terminal is fixedly mounted within said cradle assembly and arranged such that whenever said wireless pointer device is placed within said cradle assembly, a connection is made between said charge-transfer terminal of said cradle assembly and said charge-receiving terminal of said wireless pointer device.

9. The method as set forth in claim 1 and further including providing means for selectively closing said cradle assembly to a position within said portable computer and locking said cradle assembly in place whereby said wireless pointer device is carried within said cradle assembly while said portable computer is moved from a first location to a second location.

10. The method as set forth in claim 9 and further including contouring said cradle assembly in a manner corresponding to a shape of said wireless pointer device such that said wireless pointer device is held securely in place in said cradle assembly.

11. A computer comprising:
a base unit for housing components of said computer;
a wireless communication terminal mounted on said base unit, said wireless communication terminal being arranged for selective coupling to a wireless pointer device for receiving input to said computer from a user; and
a pointer housing structure within said base unit for housing said wireless pointer device, said pointer housing structure being accessible for receiving said wireless pointer device, said pointer housing structure further including means for closing said pointer housing structure to enclose said wireless pointer device within said base unit, said pointer housing structure further including a charge-transfer terminal to enable a charging of said wireless pointer device from said base unit.

12. The computer as set forth in claim 11 wherein said computer is a non-portable computer.

13. The computer as set forth in claim 11 wherein said computer is a portable computer, said base unit including a keyboard arrangement, said pointer housing structure further including an ejectable cradle assembly for selectively holding said wireless pointer device within said pointer housing structure, said computer being further operable for selectively ejecting said ejectable cradle assembly from said pointer housing structure to facilitate removal of said wireless pointer device from said ejectable cradle assembly to a position outside of said ejectable cradle assembly whereby said wireless pointer device is enabled to communicate with said wireless communication terminal on said base unit of said computer.

14. The computer as set forth in claim 13 and further including a cradle assembly release button for selectively ejecting said cradle assembly from a closed position wherein said cradle assembly is within said pointer housing structure, to an open position wherein said cradle assembly is outside of said pointer housing structure, said computer further including means for selectively locking said cradle assembly in said closed position until an actuation of said cradle assembly release button.

15. The computer as set forth in claim 14 wherein said wireless communication terminal is an infrared port arranged for selectively receiving input from said wireless pointer device when said wireless pointer device is positioned in a predetermined area relative to said wireless communication terminal.

16. The computer as set forth in claim 11 wherein said computer further includes a charging terminal, said wireless pointer device further including means for housing a rechargeable power source, said wireless pointer device further including a charge-receiving terminal coupled to said rechargeable power source for selectively enabling a charging of said rechargeable power source through said charge-receiving terminal.

17. The method as set forth in claim 16 wherein said charging terminal is fixedly mounted within said cradle assembly and arranged such that a connection is made between said charging terminal of said cradle assembly and said charge-receiving terminal of said wireless pointer device whenever said wireless pointer device is placed within said cradle assembly.

18. A portable computer comprising:
a base unit for housing components of said portable computer, said base unit including a keyboard arrangement;
a wireless communication terminal mounted on said base unit, said wireless communication terminal being arranged for selective coupling to a wireless pointer device for receiving input to said portable computer from a user; and
a pointer housing structure within said base unit for housing said wireless pointer device, said pointer housing structure being accessible for receiving said wireless pointer device, said pointer housing structure further including means for closing said pointer housing structure to enclose said wireless pointer device within said base unit, said pointer housing structure further including an ejectable cradle assembly for selectively holding said wireless pointer device within said pointer housing structure, said portable computer being further operable for selectively ejecting said ejectable cradle assembly from said pointer housing structure to facilitate removal of said wireless pointer device from said ejectable cradle assembly to a position outside of said ejectable cradle assembly whereby said wireless pointer device is enabled to communicate with said wireless communication terminal on said base unit of said portable computer, said portable computer further including a cradle assembly release button for selectively ejecting said cradle assembly from a closed position wherein said cradle assembly is within said pointer housing structure, to an open position wherein said cradle assembly is outside of said pointer housing structure, said computer further including means for selectively locking said cradle assembly in said closed position until an actuation of said cradle assembly release button, said wireless communication terminal comprising an infrared port arranged for selectively receiving input from said wireless pointer device when said wireless pointer device is positioned in a predetermined area relative to said wireless communication terminal, said portable computer further including a charging terminal, said wireless pointer device further including means for housing a rechargeable power source, said wireless pointer device further including a charge-receiving terminal coupled to said rechargeable power source for selectively enabling a charging of said rechargeable power source through said charge-receiving terminal, said charging terminal being fixedly mounted within said cradle assembly and arranged such that a connection is made between said charging terminal of said cradle assembly and said charge-receiving terminal of said wireless pointer device whenever said wireless pointer device is placed within said cradle assembly.
